(19) United States
(12) Patent Application Publication
(10) Pub. No.: US 2008/0278536 A1
(43) Pub. Date: Nov. 13, 2008

(54) INKJET IMAGE-FORMING APPARATUS AND METHOD THEREOF

(75) Inventors: Dong-woo Ha, Suwon-si (KR); Hee-yuel Roh, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/871,226

(22) Filed: Oct. 12, 2007

(30) Foreign Application Priority Data
May 9, 2007 (KR) 10-2007-0045101

(51) Int. Cl. B41J 2/165

(52) U.S. Cl. 347/28; 347/34

(57) ABSTRACT

An inkjet image-forming apparatus includes an inkjet head having a length corresponding to a width of a paper and a nozzle unit on which a plurality of nozzles are formed, and a maintenance unit that is formed on a lower side of the inkjet head to reciprocally move in a lengthwise direction of the inkjet head to maintain the inkjet head, and includes a carriage and a development maintaining unit attachably and detachably installed on the carriage, wherein the development maintaining unit includes a washing unit that washes away foreign materials contaminating the nozzle unit, using solvent waves generated by applying ultrasonic waves of an ultrasonic wave generation unit to a solvent contained in the washing unit, a wiping blade that wipes the foreign materials and the solvent remaining on a surface of the nozzle unit by contacting with the nozzle unit, and an ink container that contains ink ejected from the nozzles by a spitting operation of the nozzles.

### CROSS-REFERENCE TO RELATED APPLICATIONS

This application claims priority under 35 U.S.C § 119(a) from Korean Patent Application No. 10-2007-0045101, filed on May 9, 2007, in the Korean Intellectual Property Office, the disclosure of which is incorporated herein in its entirety by reference.

### BACKGROUND OF THE INVENTION

1. Field of the Invention

The present general inventive concept relates to an inkjet image-forming apparatus, and more particularly, to an inkjet image-forming apparatus having a maintenance unit to prevent color mixing between inks by removing remaining inks on an array inkjet head which has a length corresponding to a width of a paper, and a method thereof.

2. Description of the Related Art

Conventional inkjet image-forming apparatuses form an image on a paper by ejecting ink from a printing head (a shuttle type inkjet head) that reciprocally travels in a perpendicular direction (in a widthwise direction) to a moving direction of the paper by being separated a predetermined distance apart from an upper surface of the paper. The shuttle type inkjet head includes a nozzle unit on which a plurality of nozzles that eject ink are formed.

Recently, attempts have been made to realize high speed printing using an array inkjet head (a line printing type inkjet head) that includes a nozzle unit having a length corresponding to the width of the paper instead of using the shuttle type inkjet head that reciprocally travels in the widthwise direction. In the conventional image-forming apparatus using the array inkjet head, the array inkjet head is fixed and only the paper moves. Thus, a driving device of the image-forming apparatus is simple, and as such, high speed printing can be realized.

In the process of ejecting ink onto a paper, foreign materials, such as ink droplets that have not ejected, solid deposits formed by drying ink droplets, or fine dust adsorbed from the air, become attached to the nozzle unit, and thus, affect the ink ejection direction, thereby reducing printing quality. In order to maintain good printing quality, a device for removing the foreign materials that can attach to the nozzle unit is necessary.

In particular, in the array inkjet head, the nozzle unit has a length of approximately 210 mm to correspond to, for example, the width of A4 paper without considering a printing margin in a widthwise direction of the paper. Accordingly, there is a need to develop a device for removing such foreign materials that can attach to such a long nozzle unit.

### SUMMARY OF THE INVENTION

The present general inventive concept provides an inkjet image-forming apparatus having a maintenance unit to remove foreign materials attached to a nozzle unit of an array inkjet head, so as to prevent color mixing between inks, and thus, maintain good printing quality.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet image-forming apparatus including an inkjet head having a length corresponding to the width of a paper and a nozzle unit on which a plurality of nozzles are formed, and a maintenance unit that is formed on a lower side of the inkjet head to be able to reciprocally move in a lengthwise direction of the inkjet head so as to maintain the inkjet head, and includes a carriage and a development maintaining unit which is attachably and detachably installed on the carriage, wherein the development maintaining unit includes a washing unit that washes foreign materials contaminated around the nozzle unit using solvent waves generated by applying ultrasonic waves of an ultrasonic wave generation unit to a solvent contained in the washing unit, a wiping blade that wipes out the foreign materials and the solvent remaining on a surface of the nozzle unit by contacting with the nozzle unit, and an ink container that contains ink ejected from the nozzles by a spitting operation of the nozzles.

The foregoing and/or other aspects and utilities of the present general inventive concept may also be achieved by providing an inkjet image-forming apparatus, including an inkjet head having a nozzle unit on which a plurality of nozzles are formed to eject ink to form an image of a printing medium, and an existing condition maintaining unit detachably installed on the inkjet image-forming apparatus, the existing condition maintaining unit including a washing unit to wash away foreign materials contaminating the nozzle unit using a solvent, and a wiping blade to wipe away the foreign materials from the nozzle unit.

The existing condition maintaining unit may further include an ink container to contain ink ejected from the nozzles.

The washing unit may use solvent waves generated by applying ultrasonic waves of an ultrasonic wave generation unit to the solvent contained in the washing unit.

The plurality of nozzles may eject the small predetermined amount of ink when the existing condition maintaining unit moves in a lengthwise direction of the inkjet head.

The foregoing and/or other aspects and utilities of the present general inventive concept may also be achieved by providing a method of cleaning an inkjet head of an inkjet image-forming apparatus, the method including reciprocally moving a maintenance unit in a lengthwise direction of the inkjet head to maintain an existing condition of the inkjet head, washing away foreign materials contaminating the nozzle unit using solvent waves generated by applying ultrasonic waves of an ultrasonic wave generation unit to a solvent contained in the washing unit, wiping away the foreign materials from the nozzle unit and the solvent remaining on a surface of the nozzle unit by contacting the nozzle unit, and containing ink ejected from the nozzles by a spitting operation of the nozzles.

The foregoing and/or other aspects and utilities of the present general inventive concept may also be achieved by providing a method of cleaning an inkjet head of an inkjet image-forming apparatus having an existing condition maintaining unit, the method including moving the existing condition maintaining unit in a predetermined direction, ejecting a predetermined small amount of ink from a plurality of nozzles, washing away foreign materials contaminating the plurality of nozzles using a solvent, and wiping away the foreign materials from the nozzle unit.

The washing may be performed using solvent waves generated by applying ultrasonic waves of an ultrasonic wave generation unit to the solvent.

The foregoing and/or other aspects and utilities of the present general inventive concept may also be achieved by providing an inkjet image-forming apparatus, including an inkjet head having a length, and a maintenance unit disposed to move along a maintenance path having substantially a same length of the inkjet head to maintain the inkjet head.

The inkjet image-forming apparatus may further include a feeding unit to feed a sheet of paper along a feeding path disposed between the inkjet head and the maintenance path.

The inkjet head may include a plurality of head chips having nozzles to form an image on a sheet of paper, and the maintenance unit may reciprocate along the maintenance path to maintain the nozzles of the head chips.

The maintenance unit may output a solvent toward the inkjet head during the moving along the maintenance path.

The inkjet head may include a plurality of head chips arranged in the length direction, and the maintenance unit may eject the solvent toward each of the head chips.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of an inkjet image-forming apparatus according to an embodiment of the present general inventive concept;

FIG. 2 is a cross-sectional view of a maintenance unit of FIG. 1, according to an embodiment of the present general inventive concept;

FIG. 3 is a cross-sectional view illustrating an operation of filling a solvent in a solvent container of a washing unit of FIG. 2, according to an embodiment of the present general inventive concept;

FIG. 4 is a cross-sectional view illustrating an operation of washing nozzles by generating waves in a solvent by operating an ultrasonic wave generation unit of the washing unit of FIG. 2, according to an embodiment of the present general inventive concept;

FIG. 5 is a cross-sectional view illustrating an operation of cleaning a nozzle unit by contacting the nozzle unit with a wiping blade when the maintenance unit moves in a lengthwise direction of an array inkjet head, according to an embodiment of the present general inventive concept; and

FIG. 6 is a cross-sectional view illustrating an operation of ejecting ink from nozzles of the nozzle unit by spitting the ink from the nozzles when the maintenance unit moves in a lengthwise direction of the array inkjet head, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

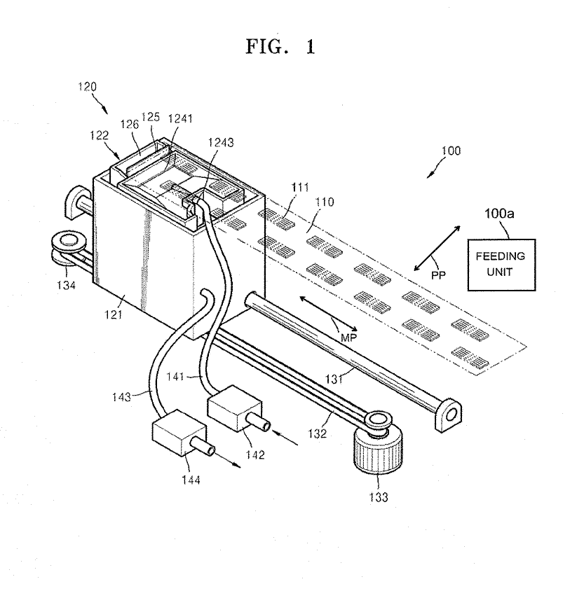

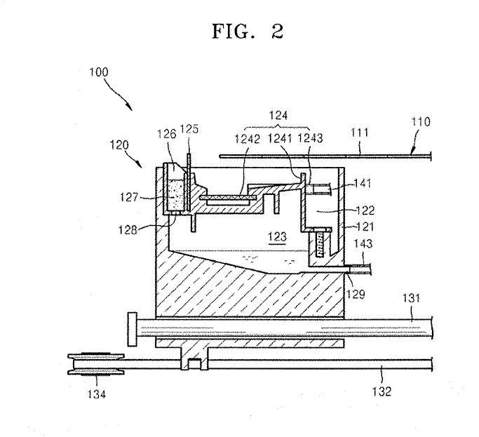

FIG. 1 is a perspective view of an inkjet image-forming apparatus 100 according to an embodiment of the present general inventive concept. FIG. 2 is a cross-sectional view of a maintenance unit 120 of FIG. 1, according to an embodiment of the present general inventive concept.

Referring to FIGS. 1 and 2, the inkjet image-forming apparatus 100 according to an embodiment of the present general inventive concept has a length corresponding to a width of a paper in a direction perpendicular to a paper feeding direction of the paper with respect to the inkjet image-forming apparatus 100, and includes an array inkjet head 110 having a plurality of nozzles 111 to eject ink on a lower side of the inkjet head 110, and the maintenance unit 120 that is formed on a lower side of the inkjet head 110, and is installed to reciprocally move along a lengthwise direction of the inkjet head 110. The maintenance unit 120 maintains the inkjet head 110 by removing foreign materials remaining around the nozzles 111 after the nozzles 111 have ejected ink.

The inkjet head 110 includes a plurality of head chips each having four nozzle lines so that each nozzle can eject yellow, cyan, magenta, and black colors, respectively, from the four nozzle lines. The head chips are disposed on the inkjet head 110 in a zigzag shape along the lengthwise direction of the inkjet head 110.

The maintenance unit 120 includes a carriage 121 and an existing condition maintaining unit 122 attachably and detachably installed on the carriage 121.

The carriage 121 is inserted into a guide shaft 131 that guides the carriage 121 so that the carriage 121 can slide in the lengthwise direction of the inkjet head 110, and is fixed by a belt 132 formed in a closed loop between a supporting roller 134 and a roller of a driving source 133. An end of the belt 132 is supported by a driving source 133, and another of the belt 132 is supported by a supporting roller 134. When the driving source 133 is operated, the belt 132 is rotated while being supported by the supporting roller 134. At this point, the carriage 121 also moves along the lengthwise direction of the inkjet head 110 by the belt 132.

A storage unit 123 is formed inside the carriage 121 to store a solvent. The existing condition maintaining unit 122 is attachably and detachably installed on the carriage 121, and the solvent that flows from the existing condition maintaining unit 122 is stored in the storage unit 123 that includes an outlet 129 to discharge materials such as the solvent to the outside.

The existing condition maintaining unit 122 includes a washing unit 124, a wiping blade 125, and an ink container 126.

The washing unit 124 includes a solvent container 1241 formed in a predetermined space to contain the solvent, and an ultrasonic wave generation unit 1242 that is formed on a lower side of the solvent container 1241 to generate ultrasonic waves. The solvent container 1241 includes a solvent inlet 1243 that allows the solvent container 1241 to be connected to the outside, and the solvent inlet 1243 is connected to a pump 142 via a connection hose 141 such that the pump 142 supplies the solvent to the solvent container 1241. The solvent may be water.

The ultrasonic wave generation unit 1242 generates waves in the solvent by applying ultrasonic waves to the solvent so that the solvent can wash the nozzles 111 by contacting the nozzles 111. Generating ultrasonic waves and the generation of waves in the solvent due to the ultrasonic waves are principles well known in the art, and thus, detailed descriptions thereof will be omitted.

The wiping blade 125 is provided close to the washing unit 124, and protrudes a predetermined height upwards. The wiping blade 125 may be formed of an elastic material so that the wiping blade 125 can clean surfaces of the nozzles 111 by bending when the wiping blade 125 contacts a lower surface of the inkjet head 110.

The ink container 126 is formed close to the wiping blade 125, has a predetermined space to contain spat ink from the nozzles 111, and includes an absorption unit 127 that can absorb the spat ink from the nozzles 111.

The ink container 126 is connected to the storage unit 123 via a through hole 128. Thus, ink stored in the ink container 126 is contained in the absorption unit 127, and then, falls into the storage unit 123.

The storage unit 123 stores both the solvent flowing from the washing unit 124 and the ink that falls from the ink container 126. The storage unit 123 is connected to a pump 144 via a connection hose 143, and thus, the solvent and the ink can be discharged to the outside through the pump 144.

A length of the maintenance path MP is substantially the same as a length of the inkjet head 110 and/or a width of the paper P.

The inkjet image-forming apparatus 100 may include a feeding unit 100a to feed a sheet of paper P along a paper path PP. The paper path PP may be disposed on a plane between a plane on which the maintenance unit 120 moves, and a plane on which the nozzles 111 are disposed.

Various operations of the maintenance unit 120 of an inkjet image-forming apparatus having the above configuration, according to an embodiment of the present general inventive concept will now be described.

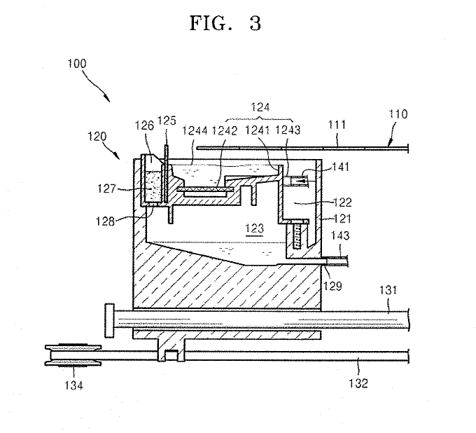

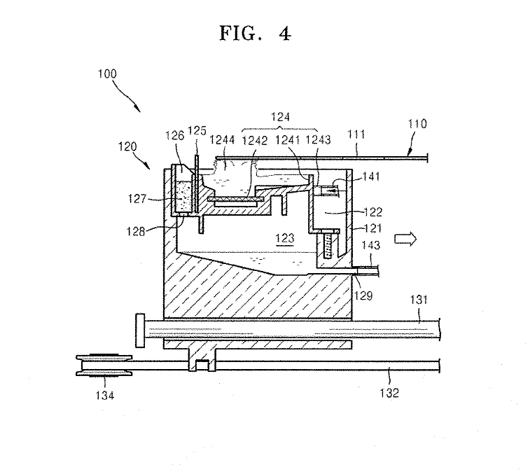

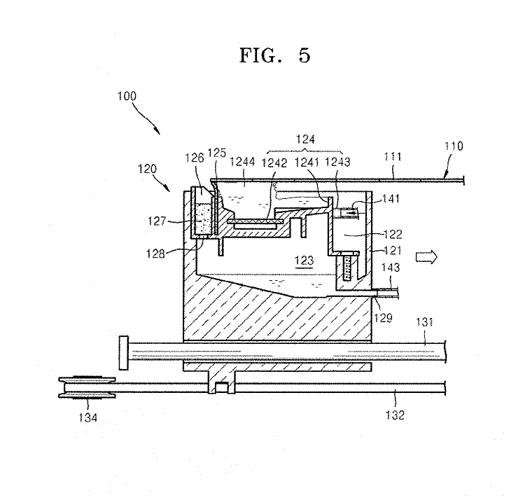

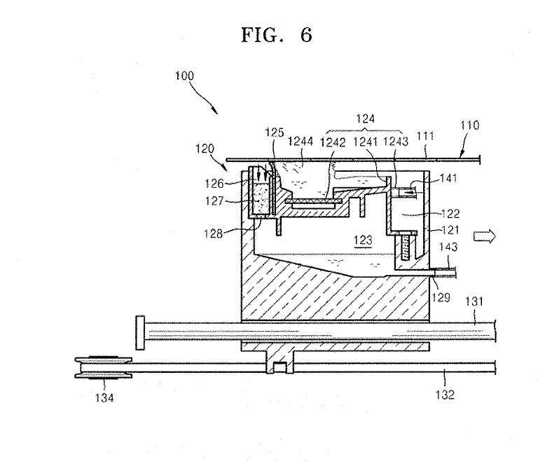

FIG. 3 is a cross-sectional view illustrating an operation of filling a solvent in the solvent container 1241 of the washing unit 124 of FIG. 2, according to an embodiment of the present general inventive concept. FIG. 4 is a cross-sectional view illustrating an operation of washing the nozzles 111 by generating waves in a solvent by operating the ultrasonic wave generation unit 1242 of the washing unit 124 of FIG. 2. FIG. 5 is a cross-sectional view for explaining an operation of cleaning a nozzle unit, on which the nozzles 111 are formed, by contacting the nozzle unit with the wiping blade 125 when the maintenance unit 120 moves in a lengthwise direction of an array inkjet head, according to an embodiment of the present general inventive concept. FIG. 6 is a cross-sectional view for explaining an operation of ejecting ink from the nozzles 111 by spitting the ink from the nozzles 111 when the maintenance unit 120 moves in a lengthwise direction of the array inkjet head, according to an embodiment of the present general inventive concept.

In FIGS. 3 through 6, like reference numerals refer to like elements.

When the inkjet head 110 performs a printing operation, the maintenance unit 120 is located on a side of the inkjet head 110. For example, as in FIG. 1, the maintenance unit 120 can move on a side of the driving source 133, and this position is called a home position, that is, the maintenance unit 120 is located on a right side of the inkjet head 110. When the printing operation by the inkjet head 110 is completed, the maintenance unit 120 is located on another side of the inkjet head 110 as depicted in FIG. 3, that is, the maintenance unit 120 is located on a left side of the inkjet head 110 as in FIG. 1.

Referring to FIG. 3, the solvent container 1241 is filled with a solvent 1244 by using the pump 142. At this point, the washing unit 124 is located on a lower side of the nozzles 111, and the wiping blade 125 and the ink container 126 are separated apart from the inkjet head 110.

Referring to FIG. 4, when ultrasonic waves are applied to the solvent 1244 by operating the ultrasonic wave generation unit 1242, solvent waves are generated, and thus, columns of the solvent 1244 contact the nozzles 111. When the columns of the solvent 1244 contact the nozzles 111 due to the ultrasonic waves, foreign materials attached to the nozzles 111 are removed by wiping the foreign materials with the wiping blade 126 as the maintenance unit 120 slowly moves in a lengthwise direction of the inkjet head 100 as indicated by an arrow in FIG. 4.

The pump 142 may continuously supply the solvent 1244 to the solvent container 1241, because when the solvent 1244 is mixed with the foreign materials attached to the nozzles 111, a concentration of the foreign materials in the solvent increases. However, if the solvent 1244 is continuously supplied to the solvent container 1241, the concentration of the foreign materials in the solvent 1244 can be reduced. Thus, a second contamination of the nozzles 111 with the foreign materials can be prevented. The solvent 1244 may be continuously supplied to the solvent container 1241 during the process of washing the nozzles 111 by operating the maintenance unit 120.

Thus, since the solvent 1244 is continuously supplied to the solvent container 1241, the solvent 1244 that overflows from the solvent container 1241 is stored in the storage unit 123.

Referring to FIG. 5, the solvent 144, in the form of waves generated by the ultrasonic wave generation unit 1242, washes the nozzles 111 as the maintenance unit 120 moves in a lengthwise direction of the inkjet head 100 as indicated by an arrow in FIG. 5. At this point, the wiping blade 125 bends by contacting the lower surface of the inkjet head 110, and cleans the nozzles 111 as the maintenance unit 120 moves in a lengthwise direction of the inkjet head 100 as indicated by the arrow. Thus, the foreign materials or the solvent 1244 remaining on surfaces of the nozzles 111 are wiped by the wiping blade 125.

Referring to FIG. 6, the nozzles 111 that have been wiped by the wiping blade 125 perform a spitting operation, that is, the nozzles 111 eject a predetermined small amount of ink downwards as the maintenance unit 120 moves in the direction indicated by the arrow. The small amount of ink ejected downwards due to the spitting operation of the nozzles 111 falls to the ink container 126, and is absorbed in the absorption unit 127 formed under the ink container 126. A purpose of the spitting operation of the nozzles 111 is to eject ink mixed with different colors to the outside. When the nozzles 111 are cleaned by washing the nozzles 111 with the solvent 1244 or by wiping the nozzles 111 with the wiping blade 125, inks of different colors can inadvertently be mixed. In order to prevent a printing image from degrading due to ink of mixed colors, the ink of mixed colors is ejected to the outside of the nozzles 111.

As described above, after the nozzles 111 have been washed by the washing unit 124 using the solvent 1244 and the surfaces of the nozzles 111 are wiped using the wiping blade 125 as the maintenance unit 120 moves in a lengthwise direction of the inkjet head 100 as indicated by the arrow in FIG. 6, the ink ejection operation is continuously performed by the spitting operation of the nozzles 111. Thus, the surfaces of the nozzles 111 are cleaned, thereby preventing a printing image from degrading due to a mixing of ink of mixed colors.

An inkjet image-forming apparatus according to an embodiment of the present general inventive concept has the following advantages.

First, foreign materials and a solvent contaminated on surfaces of nozzles are removed by continuously performing washing and wiping operations. Thus, contamination of perimeter devices around the inkjet head with the solvent and the foreign materials can be prevented.

Second, a spitting operation to eject a small amount of ink is performed by the nozzles that have been washed and wiped, thus, mixing of ink colors can be prevented, thereby increasing printing image quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image-forming apparatus, comprising:
an inkjet head having a length corresponding to a width of a paper and a nozzle unit on which a plurality of nozzles are formed; and
a maintenance unit formed on a lower side of the inkjet head to reciprocally move in a lengthwise direction of the inkjet head to maintain an existing condition of the inkjet head, comprising a carriage and an existing condition maintaining unit attachably and detachably installed on the carriage,
wherein the existing condition maintaining unit comprises:
a washing unit to wash away foreign materials contaminating the nozzle unit using solvent waves generated by applying ultrasonic waves of an ultrasonic wave generation unit to a solvent contained in the washing unit,
a wiping blade to wipe away the foreign materials from the nozzle unit and the solvent remaining on a surface of the nozzle unit by contacting the nozzle unit, and
an ink container to contain ink ejected from the nozzles by a spitting operation of the nozzles.

2. The inkjet image-forming apparatus of claim 1, further comprising:
a storage unit provided on a lower side of the development-maintaining unit to store the solvent that flows from the development maintaining unit.

3. The inkjet image-forming apparatus of claim 1, wherein the wiping blade protrudes a predetermined height upwards between the washing unit and the ink container and is formed of an elastic material.

4. The inkjet image-forming apparatus of claim 1, wherein the washing unit comprises:
a solvent container to store the solvent; and
an ultrasonic wave generation unit provided on a lower side of the solvent container to generate ultrasonic waves.

5. An inkjet image-forming apparatus, comprising:
an inkjet head having a nozzle unit on which a plurality of nozzles are formed to eject ink to form an image of a printing medium; and
an existing condition maintaining unit detachably installed on the inkjet image-forming apparatus, the existing condition maintaining unit comprising:
a washing unit to wash away foreign materials contaminating the nozzle unit using a solvent, and
a wiping blade to wipe away the foreign materials from the nozzle unit.

6. The inkjet image-forming apparatus of claim 5, wherein the existing condition maintaining unit further comprises:
an ink container to contain ink ejected from the nozzles.

7. The inkjet image-forming apparatus of claim 5, wherein the washing unit uses solvent waves generated by applying ultrasonic waves of an ultrasonic wave generation unit to the solvent contained in the washing unit.

8. The inkjet image-forming apparatus of claim 5, wherein the plurality of nozzles eject the small predetermined amount of ink when the existing condition maintaining unit moves in a lengthwise direction of the inkjet head.

9. A method of cleaning an inkjet head of an inkjet image-forming apparatus, the method comprising:
reciprocally moving a maintenance unit in a lengthwise direction of the inkjet head to maintain an existing condition of the inkjet head;
washing away foreign materials contaminating the nozzle unit using solvent waves generated by applying ultrasonic waves of an ultrasonic wave generation unit to a solvent contained in the washing unit;
wiping away the foreign materials from the nozzle unit and the solvent remaining on a surface of the nozzle unit by contacting the nozzle unit; and
containing ink ejected from the nozzles by a spitting operation of the nozzles.

10. A method of cleaning an inkjet head of an inkjet image-forming apparatus having an existing condition maintaining unit, the method comprising:
moving the existing condition maintaining unit in a predetermined direction;
ejecting a predetermined small amount of ink from a plurality of nozzles;
washing away foreign materials contaminating the plurality of nozzles using a solvent, and
wiping away the foreign materials from the nozzle unit.

11. The inkjet image-forming apparatus of claim 10, wherein the washing is performed using solvent waves generated by applying ultrasonic waves of an ultrasonic wave generation unit to the solvent.

12. An inkjet image-forming apparatus, comprising:
an inkjet head having a length; and
a maintenance unit disposed to move along a maintenance path having substantially a same length of the inkjet head to maintain the inkjet head.

13. The inkjet image-forming apparatus of claim 12, further comprising:
a feeding unit to feed a sheet of paper along a feeding path disposed between the inkjet head and the maintenance path

14. The inkjet image-forming apparatus of claim 12, wherein the inkjet head comprises:
a plurality of head chips having nozzles to form an image on a sheet of paper, and
the maintenance unit reciprocates along the maintenance path to maintain the nozzles of the head chips.

15. The inkjet image-forming apparatus of claim 12, wherein the maintenance unit outputs a solvent toward the inkjet head during the moving along the maintenance path.

16. The inkjet image-forming apparatus of claim 15, wherein the inkjet head comprises:
a plurality of head chips arranged in the length direction, and
the maintenance unit ejects the solvent toward each of the head chips.
